(19) United States
(12) Patent Application Publication
(10) Pub. No.: US 2006/0090154 A1
(43) Pub. Date: Apr. 27, 2006

(54) System and method for contributing remote object content to an integrated development environment type-ahead

(75) Inventors: Leugim A. Bustelo, Austin, TX (US); Andrew Douglas Hately, Austin, TX (US); Julio Eloy Ruano, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/960,613

(22) Filed: Oct. 7, 2004

(51) Int. Cl. G06F 9/44

(52) U.S. Cl. 717/110

(57) ABSTRACT

A system, method, and program product for enhancing keyword contribution to a code-completion facility used in association with an Integrated Development Environment source code editor. A code-completion facility supporting a source code editor includes a look-up module that retrieves keywords from a keyword compare pool responsive to a code-completion prompt. The code-completion facility further includes a contribution mechanism for contributing keywords derived from system artifacts to the keyword compare pool. The contribution mechanism includes a remote artifact contribution module for obtaining or deriving keywords from remote object interface definitions and contributing the same to the keyword compare pool. In a preferred embodiment, the remote artifact contribution module includes a keyword prediction module for accessing a remote object interface repository, predicting one or more remote object based keywords in accordance with remote object interface definition data, and contributing one or more of the predicted keywords to the code-completion facility.

### CROSS-REFERENCE TO RELATED APPLICATIONS

The present application is related to co-pending U.S. patent application No. ______, titled “SYSTEM AND METHOD FOR REVEALING REMOTE OBJECT STATUS IN AN INTEGRATED DEVELOPMENT ENVIRONMENT,” filed concurrently herewith, and incorporated herein by reference in its entirety.

### BACKGROUND OF THE INVENTION

1. Technical Field

The present invention relates generally to the field of integrated software development environments, and in particular to facilitating source code editor anticipation of remote object syntax.

2. Description of the Related Art

Over time computer programs and the software programming languages utilized to develop them have become more complex. Computer programs are typically composed of many different source code files and programming libraries. These libraries include system libraries, networking libraries and utility libraries comprising many different functions or methods. In addition, object oriented languages employ function overloading in which multiple functions or methods within a class hierarchy share the same identifier name, but have differing numbers of parameters or differing parameter types. Because of the proliferation of libraries and classes, the number of functions available to a software developer has steadily risen. This makes it very difficult if not impossible for a software developer to remember the calling sequence for a particular function.

In addition to function definitions, classes in object oriented languages typically have member attributes and properties used to define varying aspects of the class. Often the source code defining these attributes includes comments associated with the attributes indicating how they are utilized. The number of these attributes in any single class can grow quite large, and combined with the fact that attributes can be inherited from parent classes can make it difficult for a software developer to remember the purpose and use for a particular attribute.

A further factor complicating software development efforts is the fact that a software module often defines a large number of identifiers. These identifiers comprise type definitions, variables, macros, parameters, namespaces, templates, attributes, etc. and must each have a type, declaration and/or definition specified. It is often difficult for a developer to remember the type and identifier for these entities or the context in which they are applicable.

A prominent approach to managing the complexity of modern software development is the use of an Integrated Development Environment (IDE). IDEs typically support various on-line help mechanisms allowing, for example, a developer to reference on-line documentation describing varying function definitions. Furthermore, for program development of a distributed application, it is important that information about remote objects be available to the developer. Remote objects are applications that do not reside on the computer executing the application code. These objects are able to be requested by the program using techniques such as a Remote Procedure Call (RPC). For example, the Java Remote Method Invocation (RMI) is a type of access to remote objects that a programmer, using the Java programming language, employs to access objects on different platforms over a distributed network.

Remote objects are often developed in a source language different than that of the accessing application. In addition, the remote objects may operate in an operating system environment different from the operating system environment of the accessing application. An Object Request Broker (ORB) architecture is used in such situations to enable local/client objects to access and use remote/server objects. An Interface Definition Language (IDL) defines the interfaces to the remote objects that the respective applications must use to access ORB services. An “object broker” then manages the communication between object-oriented client programs and remote object services, enabling a program or object written in one language to communicate with a remote object written in another language. There are a number of interface definition languages including the Common Object Request Broker Architecture (CORBA) IDL and the Web Services Descriptor Language (WSDL) IDL. The present invention is not limited to a particular IDL. An IDL is used by a client program through “stub” interfacing. The IDL is interpreted by an “IDL compiler” to generate program stubs in the programming language of the client program. When utilized in RMI, a stub program residing on the client side appears to the local calling program to be the remote object being called to provide a service.

An important feature of most IDEs is a type-ahead function in the IDE source code editor. Type-ahead functions are familiar to most computer users and are generally characterized as utilizing some type of string matching that provides an essentially real-time comparison between a partial text string entered by the user and the contents of a keyword comparison database. Responsive to a match being found the type-ahead function displays one or more potential matching strings to complete the partial text string from which the user may select using a user pointing device.

Modern IDEs use type-ahead functionality to address the aforementioned problem of the sheer volume of available program functions making it impossible for a code editor to remember available resources and call sequences. Specifically, a typical IDE source code editor includes a code-completion mechanism that assists the human code editor in entering correct and complete source code resource names from a partial typed-in string. In conducting its automatic real time or user-prompted string matching function, the code-completion mechanism draws its compare keywords from artifact resources that are currently available to the current IDE project. The compare keywords are extracted or derived from the source code of the current project, libraries in the current CLASSPATH and other projects currently open in the IDE.

In this manner, the type-ahead/code-completion function greatly facilitates the source code editing process by providing an efficient mechanism by which a programmer can use local artifact data for code completion.

While useful for facilitating a more efficient IDE code editing process, the foregoing mechanism fails to incorporate the source code syntax associated with remote resources (referred to herein generically as “remote objects”) in the type-ahead compare keyword pool. As explained above, an ORB architecture employing IDLs is utilized to generate program stubs on the local platform which may be used as a resource conduit to access remote resources. Unless these stubs have been previously generated, their interfaces are not available to the type-ahead function of the IDE. Expanding the type-ahead compare pool to include keywords derived from remote object artifacts using conventional IDE architecture thus requires processing all IDLs through a stub generation mechanism to generate local stubs which can then be used to contribute keywords to the local type-ahead function. The delay and processing steps required to retrieve the desired remote object keywords significantly defeats the intended purpose of the type-ahead mechanism as providing a minimal disruption to the editor's train of thought. Furthermore, generating stubs for use in determining remote object syntax is an inefficient expenditure of time and processing resources since the stubs are often not currently needed for compiling or running a program that remains largely incomplete. From the foregoing, it can be appreciated that a need exists for an improved method and system for contributing remote object syntax to a local type-ahead keyword compare pool. The present invention addresses this and other needs unresolved by the prior art.

### SUMMARY OF THE INVENTION

A system, method, and program product for enhancing keyword contribution to a code-completion facility used in association with an Integrated Development Environment source code editor are disclosed herein. A code-completion facility supporting a source code editor includes a look-up module that retrieves keywords from a keyword compare pool responsive to a code-completion prompt. The code-completion facility further includes a contribution mechanism for contributing keywords derived from system artifacts to the keyword compare pool. The contribution mechanism includes a remote artifact contribution module for obtaining or deriving keywords from remote object interface definitions and contributing the same to the keyword compare pool. In a preferred embodiment, the remote artifact contribution module includes a keyword prediction module for accessing a remote object interface repository, predicting one or more remote object based keywords in accordance with remote object interface definition data, and contributing one or more of the predicted keywords to the code-completion facility.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a data processing system adapted for implementing remote object type-ahead contribution in accordance with the present invention;

FIG. 2 is a high-level block diagram illustrating an IDE source code editor adapted for implementing remote object type-ahead contribution in accordance with the present invention;

FIG. 3 is a high-level block diagram depicting a code-completion facility utilized in association with an IDE source code editor in accordance with the present invention;

FIG. 4 is a block diagram illustration of a remote artifact contribution system in accordance with a preferred embodiment of the present invention;

FIG. 5 is a high-level flow diagram depicting steps performed within an IDE source code editor environment for establishing and utilizing the code-completion features of the present invention; and

FIG. 6 is a high-level flow diagram illustrating steps performed during remote object contribution in accordance with a preferred embodiment of the present invention.

### DETAILED DESCRIPTION OF ILLUSTRATIVE EMBODIMENT(S)

The present invention is generally directed to a method, system and computer program product that enhances type-ahead or code-completion functionality in an Integrated Development Environment (IDE). IDEs are used for developing software for use in a distributed computing environment in which programs incorporate local and remote resources physically and logically distributed across networked clients and servers. A significant characteristic of such computing environments as it relates to the present invention is that the code development environments employ object-oriented programming architectures incorporating local and remote objects. The distributed objects are distinct code modules often rendered in different programming languages that can be accessed by local or remote clients via method invocations. The Common Object Request Broker Architecture (CORBA) and Java Remote Method Invocation (RMI) architectures employ Interface Definition Language (IDL) facilities to describe remote object program resources and support distributed object sharing within such frameworks. Interface Definition Languages can include CORBA IDL, Web Services Definition Language (WSDL), Java RMI descriptors as well as registry information in Universal Description Discovery and Integration (UDDI) or Java Naming Directory Interface (JNDI) form or repositories such as XMLRR or Lotus Notes Data Objects. All of these IDLs will be referred to in the following discussion as an “IDL.”

Source code editing is fundamental to IDE software development. Included with most IDE source code editors is a type-ahead or code-completion feature that assists a programmer with entering text code strings during source code entry. IDE code-completion utilities reduce the need for the user to spend time looking up help information such as class definitions while entering code syntax for software components that are often constructed from complex object classes comprising numerous class members and methods. As explained in further detail below, the present invention improves upon conventional IDE type-ahead/code-completion mechanisms by leveraging extant remote interfacing facilities such as IDLs to enhance the keyword compare pool utilized for code-completion tasks. In the following description relating to the invention as implemented in an IDE, reference is made to keywords associated with local and remote object resources. As utilized herein, a “keyword” refers to a language-specific object identifier or indicia consistent with source code syntax such as identifiers or names for an object type, class, method, method signature, etc. Remote objects are program resources accessed using remote services access tools such as an Object Request Broker (ORB) or Java RMI invocation. In contrast, local objects are locally stored with the program under development.

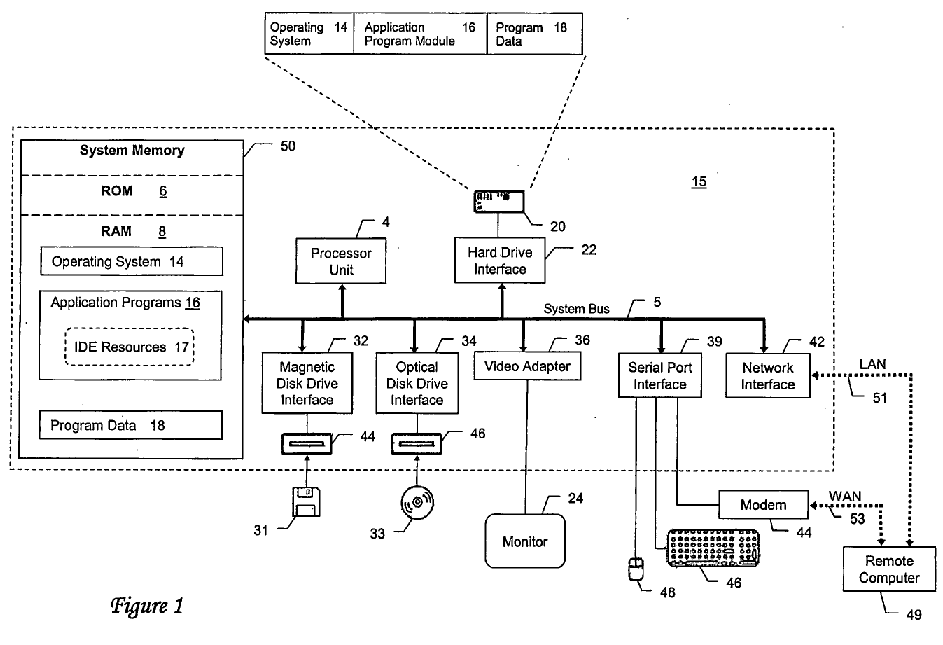

With reference now to the figures, wherein like reference numerals refer to like and corresponding parts throughout, and in particular with reference to FIG. 1, there is depicted a data processing system adapted for implementing the present invention. For discussion purposes, the data processing system is described as a personal computer, such as a desktop or portable computer. However, as used herein, the terms “data processing system,” “computer,” and the like, are intended to mean essentially any type of computing device or machine that is capable of running a software product.

While the invention will be described in the general context of application programs that run on an operating system in conjunction with a personal computer, those skilled in the art will recognize that the invention may also be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including multiprocessor systems, microprocessor-based or programmable consumer electronics, minicomputers, mainframe computers, and the like.

The exemplary data processing system illustrated in FIG. 1 generally comprises a personal computer 15, having a processing unit 4, a system memory 50, and a system bus 5 that couples system memory 50 to processing unit 4. The system memory 50 includes read only memory (ROM) 6 and random access memory (RAM) 8. Personal computer 15 further includes a hard disk drive 20, a magnetic disk drive 44, e.g., to read from or write to a removable disk 31, and an optical disk drive 46, e.g., for reading a CD-ROM disk 33 or to read from or write to other optical media. Hard disk drive 20, magnetic disk drive 44, and optical disk drive 46 are connected to system bus 5 by a hard disk drive interface 22, a magnetic disk drive interface 32, and an optical drive interface 34, respectively. The drives and their associated computer-readable media provide non-volatile storage for personal computer 15.

A number of program modules may be stored in the drives and system memory 50, including an operating system 14, application program modules 16, and program data 18. In accordance with the depicted embodiment, a set of one or more IDE program resources 17 are further included as applications within system memory 50. As explained in further detail below, IDE program resources 17 include source code development utilities and supporting programs and instructions enabling a programmer to develop source code in a distributed environment.

A user may enter commands and information into personal computer 15 through a keyboard 46 and pointing device, such as a mouse 48. Other input devices (not shown) may include a microphone, joystick, game pad, satellite dish, scanner, or the like. These and other input devices are often connected to processing unit 4 through a serial port interface 39 that is coupled to the system bus, but may be connected by other interfaces, such as a universal serial bus. A monitor 24 or other type of display device is also connected to system bus 5 via an interface, such as a video adapter 36.

Personal computer 15 may operate in a networked environment using logical connections to one or more remote computers, such as a remote computer 49. The remote computer 49 may be a server, a router, a peer device or other common network node, and typically includes many or all of the elements described relative to personal computer 15. The logical network connections depicted in FIG. 1 include a local area network (LAN) 51 and a wide area network (WAN) 53. Such networking environments are commonplace in offices, enterprise-wide computer networks, Intranets and the Internet.

When used in a LAN networking environment, personal computer 15 is connected to LAN 51 through a network interface 42. When used in a WAN networking environment, personal computer 15 typically includes a modem 44 or other means for establishing communications over WAN 53, such as the Internet. The modem 44, which may be internal or external, is connected to system bus 5 via serial port interface 39. In a networked environment, program modules depicted relative to personal computer 15, or portions thereof, may be stored in one or more remote (i.e., network distributed) memory storage devices. It will be appreciated that the network connections shown are exemplary and other means of establishing a communications link between the computers may be used.

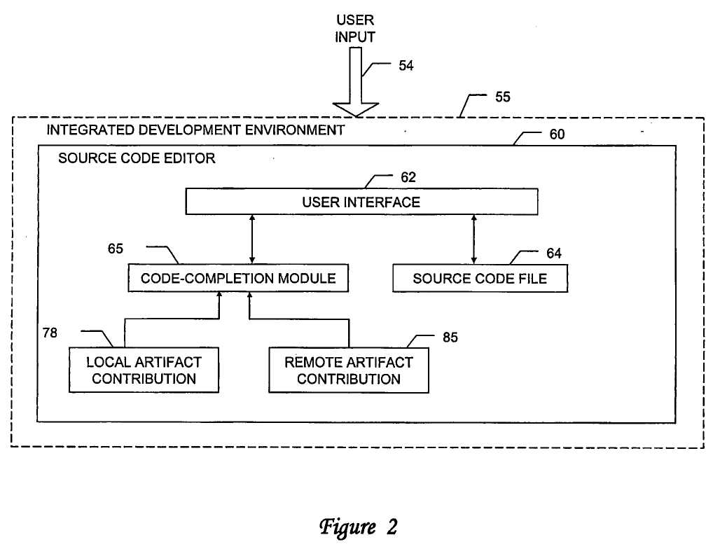

In accordance with the depicted embodiment, application programs 16 further includes IDE program resources 17 for facilitating software development. As explained in further detail with reference to FIGS. 2-6, IDE program resources 17 include program modules and instructions supporting source code entry/editing such as is employed in object-oriented software development. Supporting such source code editing is a type-ahead or “code-completion” facility that provides a user ready access to a set of code-completion keywords consistent with source code specific syntax that the user may invoke to aid in completing a partial typed-in entry.

Referring to FIG. 2, there is depicted a high-level block diagram illustrating an IDE source code editor using remote object type-ahead contribution in accordance with the present invention. Specifically, a source code editor 60 is deployed from an IDE 55 that receives local code developer input in the form of user input 54. Consistent with IDE source code editing convention, source code editor 60 generally provides text and user interface (UI) object editing tools utilized by a code developer to enter and modify programs. Source code editor 60 responds to user input 54 from input devices 46 and 48 (FIG. 1) to a user interface 62 and generates and organizes the resultant input source code data as a source code file 64 maintained in memory such as main memory 50 (FIG. 1). Source code file 64 generally comprises a text description of a program module, as written in a given programming language by a software developer.

Source code file 64 comprises a series of statements defining the data structures and actions the computer is to implement using the data structures. These statements are composed of various programming language tokens, which are combined to form declarations and definitions that describe the entities that make up the computer program. Identifiers are utilized to identify particular entities in the program, such as function names, variable names, class names, macro names and template names. Those of ordinary skill in the art will recognize that various entities and identifier mechanisms are used in various object-oriented programming languages. Although not depicted in FIG. 2, it will be appreciated by those skilled in the art that the code development tools provided within IDE 55 may further include parser, compiler, and linker functionality for rendering an executable program module (not depicted) from source code file 64.

In general, user input 54 takes the form of statements in the syntax of the programming language supported by IDE 55, but may also include input from various menus, dialogs, wizards, and other UI controls provided by user interface 62. As related to a preferred embodiment of the present invention, a given program module as embodied by source code file 64 is entered by the developer as part of a software development “project.” Such projects may be Java, C++, or similar object-oriented programming language which may include one or more class modules which each define one or more objects. Projects may also be developed in non-object oriented (procedural) languages such as C.

The system and method of the present invention are related to the text entry/editing performed during development of source code file 64. Specifically, and as shown in the depicted embodiment, the user interface 62 used by source code editor 60 is further communicatively associated with a type-ahead facility in the form of a code-completion module 65. Code-completion module 65 includes keyword lookup and retrieval functions and employs electronic and/or program modules and processing means enabling it to be invoked and utilized in support of source code text entry. Code-completion module 65 is preferably invoked by user interface 62 or other source editor prompt input and responsive thereto performs a type-ahead or code-completion search in which, for example, a latest-entered text string entered into source code file 64 is compared with keywords obtained or derived from project-linked artifacts and included in a keyword compare pool. To this end, code-completion module 65 typically performs a string-matching function and returns a dialog box, or the like, displaying a list of one or more possible keywords, in the form of qualified names for object types, classes, methods, etc. from which the developer may select as the correct entry.

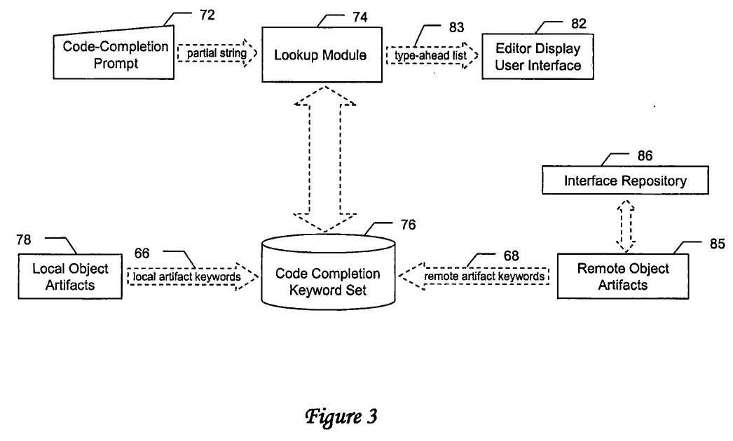

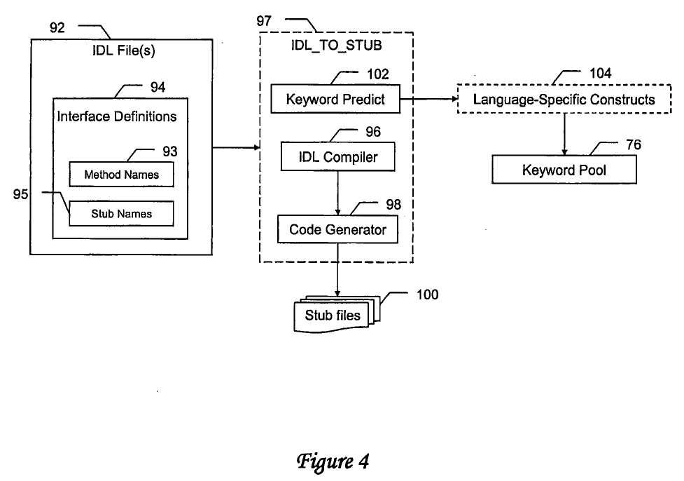

While the result of the code-completion function is implemented at the user interface level by displaying a UI dialog as described above, the system and method of the present invention are particularly related to the contribution mechanism utilized by a type-ahead or code-completion module such as that depicted in FIG. 2. As shown in the depicted embodiment, the code-completion module 65 is communicatively linked to a local artifact source 78 representing the keyword contributions from local (i.e. accessed independently of IDE remote program interfacing) resources. Typically, such locally available keyword sources 78 include identifiers from local object libraries, runtime environment object classes, and projects opened in the IDE. The present invention augments the keyword contribution mechanism by providing a remote artifact keyword contribution source 85 that includes keyword resources that are not locally available and are instead obtained or derived from interface definitions for remote objects that may be accessed by the project. Keywords provided by remote artifact keyword source 85 are preferably determined and contributed by a remote object contribution system and method of the present explained below in further detail with reference to FIGS. 3 and 4.

With reference to FIG. 3, there is illustrated a high-level block diagram depicting a code-completion facility such as may be incorporated by code-completion module 65 and utilized in association with an IDE source code editor in accordance with the present invention. The depicted code-completion facility generally comprises a code-completion prompt module 72 deployed in association with source code text editing functionality such as that depicted in FIG. 2. Code-completion prompt module 72 is communicatively coupled to a lookup module 74, which is in turn communicatively coupled to a keyword compare pool 76. In operation, and in accordance with conventional type-ahead or code-completion techniques, code-completion prompt 72 provides an automatic or user-selected invocation of lookup module 74 during source code input. In one exemplary embodiment, a developer entering a source code text string specifying a record or object class name such as within source code file 64 may enter a hot key (e.g. a <period>, <ctrl><space>, etc.) to invoke display of a dialog box providing the developer with a list of valid arguments in the form of one or more keywords. Responsive to the code-completion invoke command, the associated partial string is processed by lookup module 74, which typically performs a string matching function comparing attributes of the partial string with the content of keyword compare pool 76. The type-ahead or code-completion list 83 resulting from the string-matching function is then displayed within a source code editor display UI 82 such as may be deployed by user interface 62 within the source editor environment. The developer can then simply select from the displayed list for code-completion entry.

As noted above, the keyword compare pool 76 referenced by lookup module 74 receives keyword contributions 66 from local artifact contribution sources. Consistent with IDE code-completion convention, the local keyword contributions are obtained from local artifact sources 78 that are generally characterized as obtained or derived independently of IDE remote program interfacing (i.e. interfacing requiring object request brokering such as implemented by CORBA) and are typically linked as part of the present program project. Local artifact sources 78 typically include resources such as object type and class information from classes programmably incorporated into the runtime environment (e.g. Java Runtime Environment for Java applications), in the CLASSPATH, or in other projects that are programmably linked to the source editor program module development without IDE ORB facilitation.

The present invention substantially enhances the code-completion facility utilized in IDEs such as IDE 55 by incorporating a remote object contribution mechanism absent from known IDEs. Specifically, and as shown in FIG. 3, the depicted code-completion facility further includes a contribution of remote artifact keywords 68 that are specified and delivered to keyword compare pool 76 in accordance with the communicative linking and processing function of a remote artifact contribution module 85. Contribution module 85 is preferably communicatively linked to a remote object interface repository 86, which as explained in further detail with reference to FIG. 4, includes IDE interface resources, particularly IDL source code files, from which remote object data is determined and retrieved to be included in keyword pool 76.

With reference to FIG. 4, there is depicted a block diagram illustration of a remote artifact contribution system as may be incorporated in the embodiments shown in FIGS. 1, 2, and 3 in accordance with the present invention. The depicted system includes features enabling the remote artifact contribution mechanism to advantageously utilize IDE remote program interface tools to derive and contribute keywords to a type-ahead keyword compare pool. Such remote program interface tools are generally characterized as belonging to IDE interface definition architectures such as those employed by Interface Definition Languages (IDLs). IDLs are well-known in the IDE art field as definition or description languages (not programming languages) that are utilized to describe an object's interface; that is, the characteristics and behavior of a specified object, including the operations that can be performed on the object. IDLs are usefully employed in IDEs to facilitate the common sharing of interface definitions in which both the client and server applications require information about the available interfaces, including the objects and object-specific operations.

For illustrative purposes intended to characterize IDLs as conventionally deployed in an IDE, FIG. 4 depicts how IDL source code files are processed into client applications. Specifically, an IDL source code file 92, which may be included in a client-specified IDL registry, is prepared containing interface definitions 94. IDL source code file 92 is processed by an IDL_TO_STUB generator module 97 that includes an IDL compiler 96 for compiling source file 92 in accordance with known IDL compilation methods and the results are received and processed by a code generator 98. The code generator 98 includes program modules and instructions for generating special program interface files specified in the language of the client application. Code generator 98 and IDL compiler 96 are typically combined within a single application, such as IDL_TO_STUB generator 97, to produce the language-specific code in the form of one or more so-called program stub files 100. Together, IDL compiler 96 and code generator 98 translate a specified object's interface into a specific programming language according to ORB mapping specified by the IDL interface definitions 94.

As explained above, the generated stubs are truncated extensions of the programs that are compiled into them and appear to the local calling program to be the respective program being called for a service. Stub files 100 are compiled by a language-specific compiler (not depicted) and linked to the client application making the call. In this manner the IDL generation of stubs provides comprehensive remote program resources that may be utilized during compilation and/or program runtime. However, the foregoing described stub generation processing requires significant processing resources and time. As illustrated in FIGS. 4, 5, and 6, the present invention provides remote object artifact contribution to a type-ahead or code-completion facility without interrupting and burdening the source editor processing environment with stub file generation.

Specifically, and referring again to FIG. 4, the depicted embodiment employs a keyword prediction module 102 such as may be incorporated or utilized by remote contribution module 85 in obtaining or deriving keywords from remote object artifacts contained within IDL source file 92. Keyword prediction module 102 preferably includes program modules and instructions for predicting keywords in the form of language-specific constructs such as stub file names, object method names, etc., from the remote object language artifacts. In a preferred embodiment, the remote object artifacts from which the keywords are predictively or otherwise derived are specified within the interface definitions 94 of IDL source file 92. The interface definitions may include object methods names 93 and stub names 95 as well as other language and/or object specific identifiers or indicia. The predicted keywords (in some cases the source code artifacts themselves) are then included as language-specific constructs 104 that are incorporated into the available keyword compare pool 76 used for code-completion.

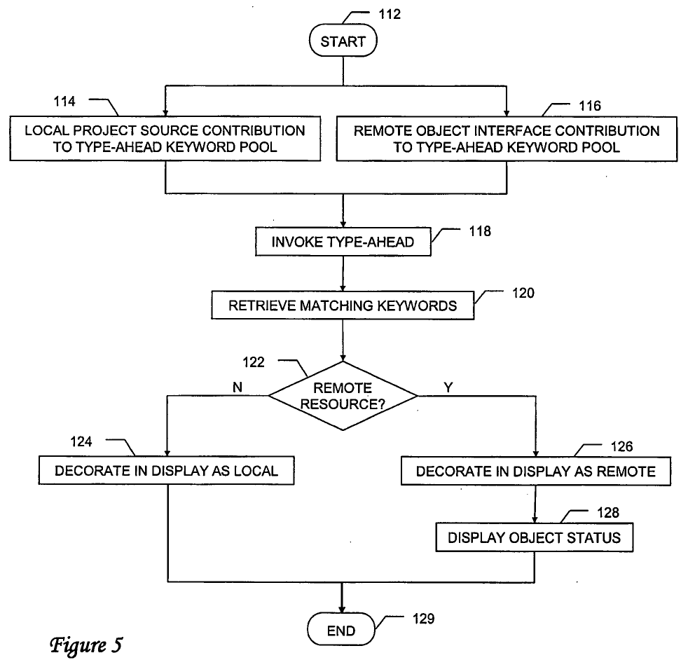

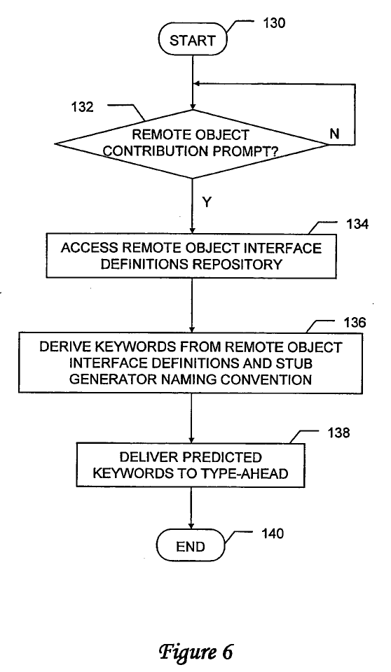

FIG. 5 illustrates a high-level flow diagram depicting steps performed within an IDE source code editor environment for establishing and utilizing the code-completion feature of the present invention. The process begins as shown at steps 112 and proceeds to steps 114 and 116 which depict local and remote object artifact contribution, respectively, to a type-ahead keyword compare pool. The local contribution depicted at step 114 generally comprises assembling and adding to a type-ahead keyword pool using local (i.e. non remote interface programming derived) IDE program language artifacts. In contrast, the remote contribution depicted at step 116 entails accessing and processing data from a remote object interface data repository such as IDE interface repository 86 (FIG. 3) in accordance with the process described below with reference to FIG. 6.

Proceeding as illustrated at steps 118 and 120, responsive to a type-ahead or equivalent code-completion invoke signal, the lookup module retrieves matching keywords from the augmented keyword pool. Such keywords may include local object artifacts if the requested resource (as identified in a partial string, for example) corresponds to a locally available resource and/or remote object artifacts if matches to the partial string correspond to keywords obtained or derived from the remote object interface resources (e.g. from an ORB interface in an IDE).

The process depicted in FIG. 5 further includes a feature by which a code developer may visually distinguish keywords for local objects from those corresponding to remote objects. The particular system and method for discriminating between local and remote object keywords is not described herein but is instead explained and depicted in co-pending U.S. application No. ______, titled “SYSTEM AND METHOD FOR REVEALING REMOTE OBJECT STATUS IN AN INTEGRATED DEVELOPMENT ENVIRONMENT,” and which is incorporated herein by reference in its entirety. Specifically, each of the keywords included in the drop-down or equivalent code-completion list is identified as corresponding to either a local or a remote object. As illustrated in steps 122 and 124, responsive to a given keyword being associated with a local object, the keyword is decorated accordingly in the code-completion list display. Likewise, if the keyword is identified as corresponding to a remote object, a designated remote object decorator is applied to the keyword in the display (steps 122 and 126). Furthermore, and as shown at step 128, the status of the remote object, as determined by an object status monitor system (described in the foregoing related U.S. application), may be optionally displayed to assist the user in assessing the present or future availability of the object. The code-completion process ends as shown at step 129.

FIG. 6 is a high-level flow diagram illustrating steps performed during remote object contribution in accordance with a preferred embodiment of the present invention. The process begins as shown at step 130 and proceeds to steps 132 with an optional step that may be included in an alternate embodiment in which an affirmative determination/detection is made of whether a remote object contribution cycle is to be commenced or updated. For example, the IDE source code editor user interface may include a user-selectable setting that is explicitly set in a property window to enable/disable remote object awareness. In an alternate embodiment, an implicit setting may be used based on the type of project (e.g. Local Java Project versus Distributed Java Project) used to package the source code. In still an alternate embodiment, the remote object contribution property may be configurable in terms of pre-selecting interface definition sources. For example, the set of available IDL files may be categorized in a user-selectable registry. The user is then able to select the set of categories (such as hierarchically) of interest.

Proceeding as shown at step 134, a remote object interface definition repository such as an IDE Interface Repository is accessed such as by a contribution module 85 having a remote object retrieval mechanism. In the depicted embodiment, and as shown at step 136, the preferred remote object retrieval mechanism is a predictive algorithm module that generates established or likely object related keywords such as method and stub names derived from the interface definitions within one or more IDL source files. As previously explained, resources such as interface definitions 94 within IDL source file 92 include remote artifacts from which keywords are obtained or predictively derived such as depicted at step 136. In a preferred embodiment, predictive algorithm module 102 employs a predictive algorithm in which the naming convention followed by a stub generation tool such as IDL compiler 96 and/or code generator 98 is utilized to predict language-specific keywords from the remote object description data included in IDL source code file 92. For example, for a service within interface definitions 94 named “foo,” the IDL conversion tool comprising IDL compiler and/or code generator may include pre-programmed naming convention instructions for generating a Java class named “fooService.” In such a case, predictive algorithm module 102 preferably includes language-specific (Java in this case) naming convention rules conforming to the IDL conversion naming convention rules such that a keyword “fooService” is predictively generated. The remote object keywords predicted or otherwise obtained or derived from IDL source code file 92 are then delivered and inserted by the remote object contribution mechanism into the type-ahead keyword pool (step 138) and the process ends as shown at step 140.

The disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like. Whether software or hardware is used to implement the systems in accordance with this invention is dependent on the speed and/or efficiency requirements of the system, the particular function, and the particular software or hardware systems or microprocessor or microcomputer systems being utilized. The computer controlled code-completion systems and methods described above, however, can be readily implemented in hardware and/or software using any known or later-developed systems or structures, devices and/or software by those skilled in the applicable art without undue experimentation from the functional description provided herein together with a general knowledge of the computer arts.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. In an Integrated Development Environment (IDE), a method for contributing keywords to a type-ahead facility for a source code editor application, said method comprising:
accessing a remote object interface repository that includes interface definitions;
determining one or more keywords from the interface definitions; and
inserting one or more of the determined keywords into the type-ahead facility.

2. The method of claim 1, said determining step comprising predicting the one or more keywords in accordance with the interface definitions and a target programming language naming convention.

3. The method of claim 2, wherein the IDE employs a stub generator naming convention for generating program stubs from the interface definitions, said predicting one or more keywords further comprising predicting one or more keywords from the interface definitions in accordance with the stub generator naming convention.

4. The method of claim 1, wherein said type-ahead facility comprises an IDE source code editor code-completion facility.

5. The method of claim 1, wherein said inserting step comprises providing the one or more determined keywords to a keyword compare pool that is accessed by the type-ahead facility during source code editing.

6. A code-completion facility utilized to support a source code editor in an Integrated Development Environment (IDE), said code-completion facility comprising:
a look-up module that retrieves keywords from a keyword compare pool; and
a contribution mechanism for contributing keywords derived from program language artifacts to the keyword compare pool, said contribution mechanism including a remote artifact contribution module for contributing keywords derived from remote object artifacts to the keyword compare pool.

7. The code-completion facility of claim 6, wherein the source code editor is utilized for developing a source code module using a specified object oriented programming language.

8. The code-completion facility of claim 6, further comprising a remote interface repository that includes remote object interface definitions.

9. The code-completion facility of claim 8, wherein said remote artifact contribution module further includes an artifact prediction module for:
determining one or more keywords based on the remote object interface definitions; and
inserting the predicted keywords to the keyword compare pool.

10. The code-completion facility of claim 9, wherein said keyword prediction module uses a stub generator naming convention for predictively determining the one or more keywords from the remote object interface definitions.

11. In an Integrated Development Environment (IDE), a computer program product for contributing keywords to a type-ahead facility for a source code editor application, said computer program product including computer-executable instructions for performing a method comprising:
accessing a remote interface repository that includes interface definitions;
determining one or more keywords from the interface definitions; and
inserting one or more of the determined keywords to the type-ahead facility.

12. The program product of claim 11, said determining step comprising predicting the one or more keywords in accordance with the interface definitions and a target programming language.

13. The program product of claim 12, wherein the IDE employs a stub generator naming convention for generating program stubs from the interface definitions, said predicting one or more keywords further comprising predicting one or more keywords from the interface definitions in accordance with the stub generator naming convention.

14. The program product of claim 11, wherein said type-ahead facility comprises an IDE source code editor code-completion facility.

15. The program product of claim 11, wherein said inserting step comprises providing the one or more determined keywords to a keyword compare pool that is accessed by the type-ahead facility during source code editing.
